(19) United States
(12) Patent Application Publication
(10) Pub. No.: US 2020/0322687 A1
(43) Pub. Date: Oct. 8, 2020

(54) System and Method of Creating a Plotline Through Audience Interaction

(71) Applicant: Ingo Joachim Schneider, Porter Ranch, CA (US)

(72) Inventor: Ingo Joachim Schneider, Porter Ranch, CA (US)

(21) Appl. No.: 16/843,878

(22) Filed: Apr. 8, 2020

Related U.S. Application Data
(60) Provisional application No. 62/831,021, filed on Apr. 8, 2019.

(51) Int. Cl. H04N 21/475; H04N 21/472; H04N 21/8541; H04N 21/8545

(52) U.S. Cl. CPC H04N 21/4758; H04N 21/8545; H04N 21/8541; H04N 21/472

(57) ABSTRACT

A method of creating a plotline though audience interaction provides a system for collecting audience development preferences and instruction and distributing that feedback to appropriate parties. The system accomplishes this by providing an application or other interface that facilitates communication and enables determination of a most-preferred outcome or series of events through a voting process. The audience can be divided into teams, preferably protagonists and antagonists. The teams are initially set in opposition to each other, with each team generating storylines for their characters. A team must determine each action of the characters in advance to stay ahead of the opposing team. The outcome of every storyline depends solely on the decisions of the audience. The show will be written and filmed according to the choices that the audience makes. Additional storylines with additional characters can further be incorporated onto the main storyline.

The current application claims a priority to the U.S. Provisional Patent application Ser. No. 62/831,021 filed on Apr. 8, 2019.

### FIELD OF THE INVENTION

The present invention generally relates to media production and consumer feedback systems. More specifically, the present invention relates to systems and methods for producing interactive media content that incorporates feedback from the audience.

### BACKGROUND OF THE INVENTION

Over the past several decades, the entertainment industry has witnessed a dramatic shift in the distribution of market attention. While live performances are alive and well and certainly essential, technological advantages and modern luxuries allow people to experience shows and other forms of entertainment from the comfort and safety of their own homes through televisions and internet connections. The in-person studio audience is still present, but the vast majority of viewership occurs remotely. This reflects a new challenge that the in-person audience was developed to address; namely, the ability for the audience to interact with the actors and showrunners directly. What is needed is a way for viewers to communicate with show writers and actors. Further desirable is a way for the audience to provide guidance to a show, so that the audience can see the exact content and interactions they are interested in.

An objective of the present invention is to provide systems and methods for producing an interactive show fully controlled by the audience. The present invention provides an entirely new way of interactive audience participation-based story telling. The present invention provides a unique way of storytelling which can be implemented on any type of media platform. The present invention provides an interactive show format which further enables fans and audience to control the show's entire plot. In the preferred embodiment of the present invention, the audience and fans are in full control of the outcome of different plotlines of a show while being participant and engaged in the production process. The present invention further provides perks and rewards for the audience to promote engagement.

In the preferred embodiment of the present invention, the audience can be divided into teams, preferably protagonists and antagonists. The teams are initially set against each other in order to generate separate storylines. The teams participate in the production of the script for most episodes of the show. Each team must determine every action of the plurality of characters in advance to stay ahead of the opposing team. The outcome of every storyline depends solely on the audiences' decisions without limitations. The show will be written and filmed according to choices that the audience makes. In the beginning, the system of the present invention provides the audience with a pilot episode in which a plurality of characters is introduced as well as a cliffhanger and a problem for the audience to solve. Then, the system of the present invention splits the show into two categories. A first category preferably corresponds to the main story which shows the outcome based on what the audience decided on. A second category preferably corresponds to a first side story which introduces new characters that will be incorporated onto the main storyline. Additional storylines with additional characters can further be incorporated onto the main storyline.

### BRIEF DESCRIPTION OF THE DRAWINGS

FIG. 1 is a block diagram illustrating the arrangement of show platforms on the remote server. FIG. 2 is a flowchart illustrating an overall process for the method of the present invention.

FIG. 3 is a continuation of FIG. 2.

FIG. 4 is a flowchart illustrating the subprocess of providing background information about the show or program.

FIG. 5 is a flowchart illustrating the subprocess of dividing audience members into appropriate teams.

FIG. 6 is a flowchart illustrating the subprocess of adding contributions to a show decision-making forum.

FIG. 7 is a flowchart illustrating the subprocess of determining the best contribution for submission to the showrunners.

FIG. 8 is a continuation of FIG. 7.

FIG. 9 is a flowchart illustrating the subprocess of utilizing a countdown timer.

FIG. 10 is a flowchart illustrating the subprocess of providing filler episodes for the show or program.

### DETAILED DESCRIPTION OF THE INVENTION

All illustrations of the drawings are for the purpose of describing selected versions of the present invention and are not intended to limit the scope of the present invention.

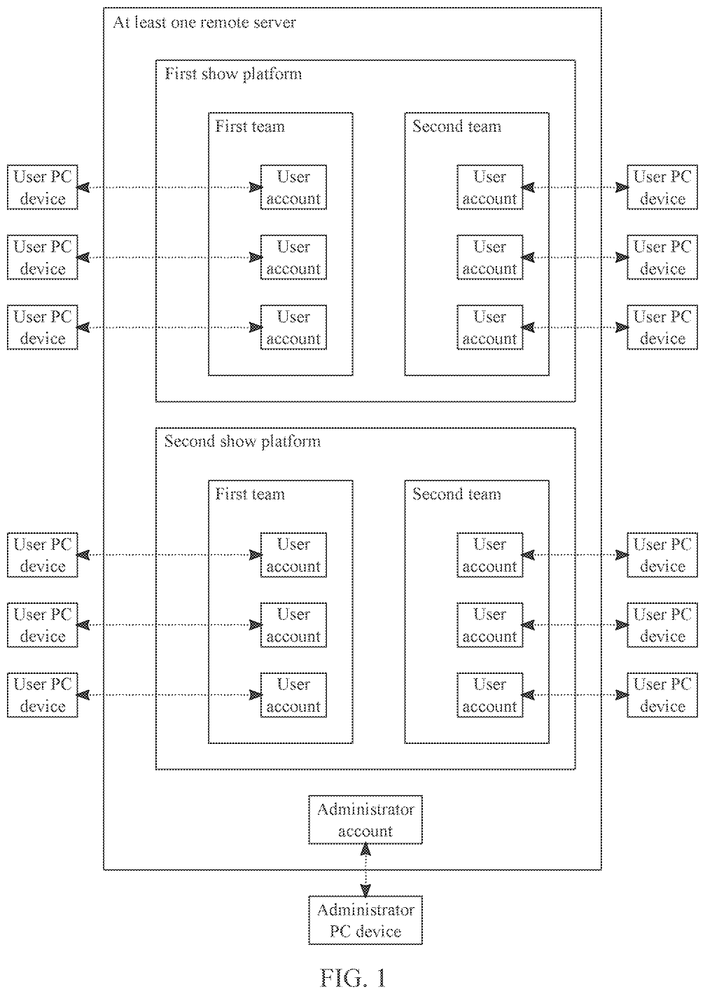

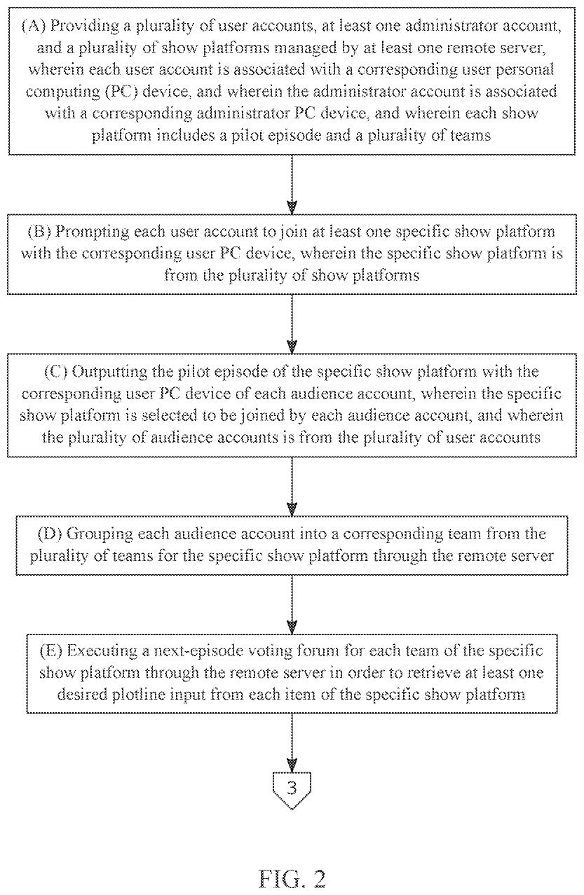

The present invention is a method of creating a plotline though audience interaction that provides a system for collecting audience instruction and distributing that feedback to appropriate parties. The present invention accomplishes this by providing an application or other interface that facilitates communication and enables determination of a most-preferred outcome or series of events through a voting process. The system of the present invention includes a plurality of user accounts, at least one administrator account, and a plurality of show platforms managed by at least one remote server, wherein each user account is associated with a corresponding user personal computing (PC) device, and wherein the administrator account is associated with a corresponding administrator PC device, and wherein each show platform includes a pilot episode and a plurality of teams (Step A), as represented in FIG. 1-2. The plurality of user accounts relates to a set of individuals who contribute to the development of a plotline. The at least one administrator account relates to showrunners, actors, or a variety of managerial positions within a show organization responsible for the development of a script, scenery, effects, cinematography, audio, staff, and other such tasks vital to the production of the show or media. The plurality of show platforms relates to a set of available shows or programs that the plurality of user accounts may select for subsequent development. The at least one remote server relates to a computer capable of connecting wirelessly to an array of PC devices through the internet, collecting and storing data, applying programmed logic, and relaying results to appropriate parties. The corresponding user PC device relates to any of smartphones, laptops, desktop computers, or a variety of other devices capable of allowing the user to communicate with the remote server. Similarly, the corresponding administrator PC device relates to any of smartphones, laptops, desktop computers, or a variety of other devices capable of allowing an administrator to communicate with the remote server. The pilot episode relates to a production in which the characters, setting, and initial problems are introduced, thereby generating the foundation of the show for at least one given season or session. The plurality of teams represents a set of character viewpoints that a user account may choose to develop. In an exemplary embodiment, the plurality of teams is divided into protagonists and antagonists; however, it is to be understood that given potential story complexity and inevitable character development, the plurality of teams may evolve and change into multiple sections of somewhat-aligned characters, or may even divide into individual character development, and the preferred embodiment is not meant to be limiting.

The overall process for the method of the present invention allows the provided participants, accounts, and devices to coordinate and communicate relevant information to different parties during the show production process. Each user account is prompted to join at least one specific show platform with the corresponding user PC device, wherein the specific show platform is from the plurality of show platforms (Step B). In this way, each user account may choose the specific show or program that the user account is interested in contributing to. The pilot episode of the specific show platform is outputted with the corresponding user PC device of each audience account, wherein the specific show platform is selected to be joined by each audience account, and wherein the plurality of audience accounts is from the plurality of user accounts (Step C). The pilot episode provides the structure, including challenges, different types of character interactions, preexisting relationships, backgrounds, settings, and more, upon which the plurality of audience accounts may build. Next, each audience account is grouped into a corresponding team from the plurality of teams for the specific show platform through the remote server (Step D). Each audience account is preferably grouped based on an inputted preference for a specific team, but accounts may also be placed into teams based on necessity for achieving reasonably balanced team size numbers.

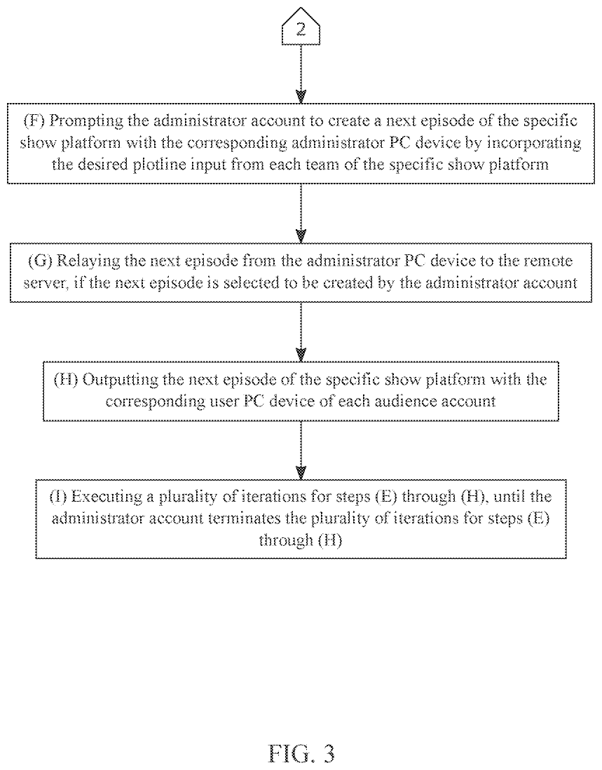

After dividing into teams, the plurality of audience accounts must determine the most appropriate or exciting outcome for a given scene. A next-episode voting forum is executed for each team of the specific show platform through the remote server in order to retrieve at least one desired plotline input from each team of the specific show platform (Step E). The next-episode voting forum relates to a platform upon which a set of users may share their ideas and vote upon which idea they believe to be best. Such a system facilitates determination of the most popular ideas for the next episode of the show or program. The at least one desired plotline input relates to a textual description of a potential event or development in the story that has been submitted into the next-episode voting forum for approval. Subsequently, the administrator account is prompted to create a next episode of the specific show platform with the corresponding administrator PC device by incorporating the desired plotline input from each team of the specific show platform (Step F), as represented in FIG. 3. Thus, the administrator account is provided with detailed information and insights from interested viewers about the most desired direction for the show or program plot. The next episode is then relayed from the administrator PC device to the remote server, if the next episode is selected to be created by the administrator account (Step G). In this way, the next episode is available for subsequent storage or distribution by the remote server. The next episode of the specific show platform is outputted with the corresponding user PC device of each audience account (Step H). Thus, the plurality of audience accounts is able to view the results of their work, oftentimes progressing towards a catharsis or hurling towards a catastrophe depending upon the results of the interactions between the different teams. Finally, a plurality of iterations is executed for Steps E through H, until the administrator account terminates the plurality of iterations for Steps E through H (Step I). In this way, new episodes and information are continuously created, developed, and seen until the administrator decides to conclude the show or program.

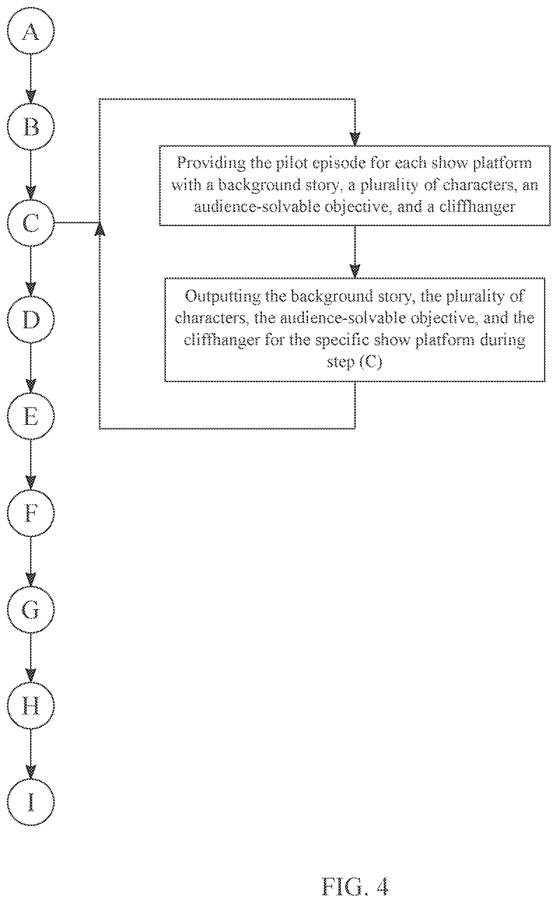

The pilot episode must provide information that will assist the plurality of audience accounts in making subsequent decisions about the direction of the show and desirable character interactions. To this end, the pilot episode for each show platform is provided with a background story, a plurality of characters, an audience-solvable objective, and a cliffhanger, as represented in FIG. 4. The background story often takes the form of exposition or visual description and provides detail about the history of a character. The plurality of characters relates to the set of generally fictional people represented by actors who are part of the larger story. The audience-solvable objective relates to a problem or conflict within the story that serves as an overarching guideline for parties developing various aspects of the plot and character development. The cliffhanger is an inevitable event that the showrunners have planned, serving also as a guideline for plot development. The background story, the plurality of characters, the audience-solvable objective, and the cliffhanger for the specific show platform are outputted during Step C. Thus, the plurality of audience accounts is provided with the framework necessary to build a cohesive and logical story with minimal guidance from directors and showrunners.

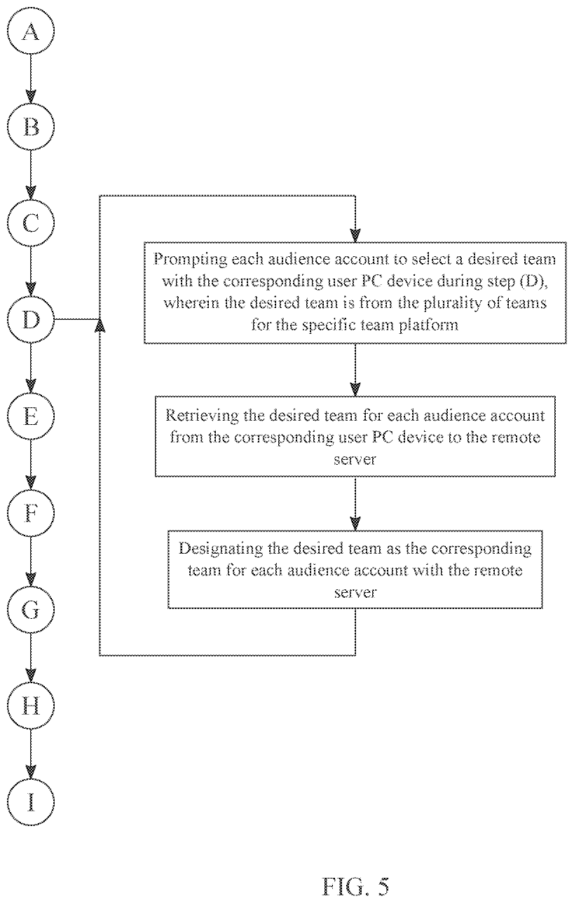

Each audience account of the plurality of audience accounts will have opinions about different characters or groups of characters and will therefore want to make decisions affecting a specific group within a story. To enable this, each audience account is prompted to select a desired team with the corresponding user PC device during Step D, wherein the desired team is from the plurality of teams for the specific team platform, as represented in FIG. 5. The desired team may relate generally to a group of protagonists or antagonists, or may relate to subsets of groups or individuals, depending upon the progression of the plot and character development. The desired team for each audience account is then retrieved from the corresponding user PC device to the remote server. The remote server therefore gains access to data connecting each audience account to their respective desired team. Next, the desired team is designated as the corresponding team for each audience account with the remote server. Therefore, each audience account gains access specifically to the corresponding team with respect to the next-episode voting forum.

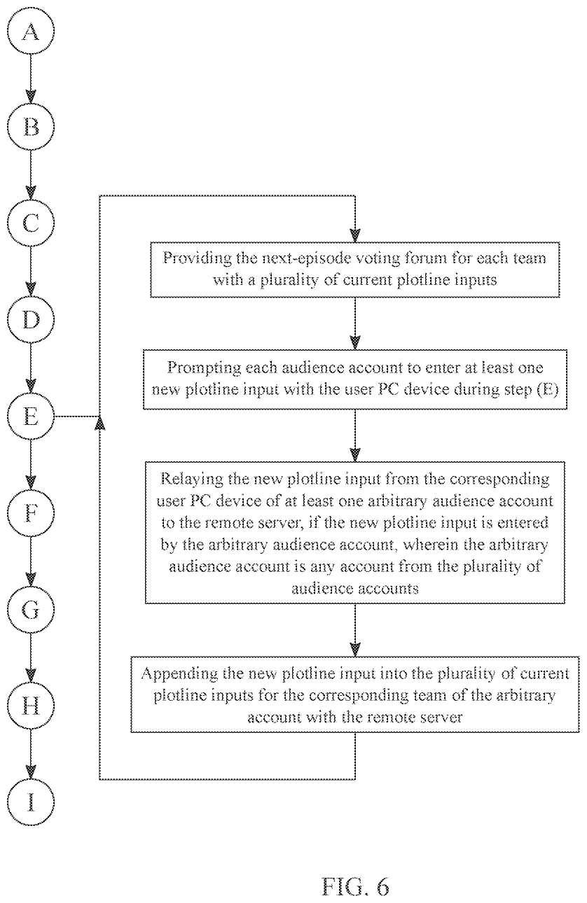

The next-episode voting forum must provide a democratic system for presenting and sorting through content written by each team. To achieve this, the next-episode voting forum for each team is provided with a plurality of current plotline inputs, as represented in FIG. 6. The plurality of current plotline inputs relates to the different written ideas expressed by the various members of the corresponding team. Each audience account is prompted to enter at least one new plotline input with the user PC device during Step E. Such an arrangement provides each audience account with the opportunity to contribute to story development. The new plotline input is subsequently relayed from the corresponding user PC device of at least one arbitrary audience account to the remote server, if the new plotline input is entered by the arbitrary audience account, wherein the arbitrary audience account is any account from the plurality of audience accounts. This arrangement allows the remote server to collect, store, and interact with the new plotline input for subsequent use. The new plotline input is then appended into the plurality of current plotline inputs for the corresponding team of the arbitrary account with the remote server. In this way, the new plotline input can be created by anybody, thus adding to the excitement of creating a new plotline input.

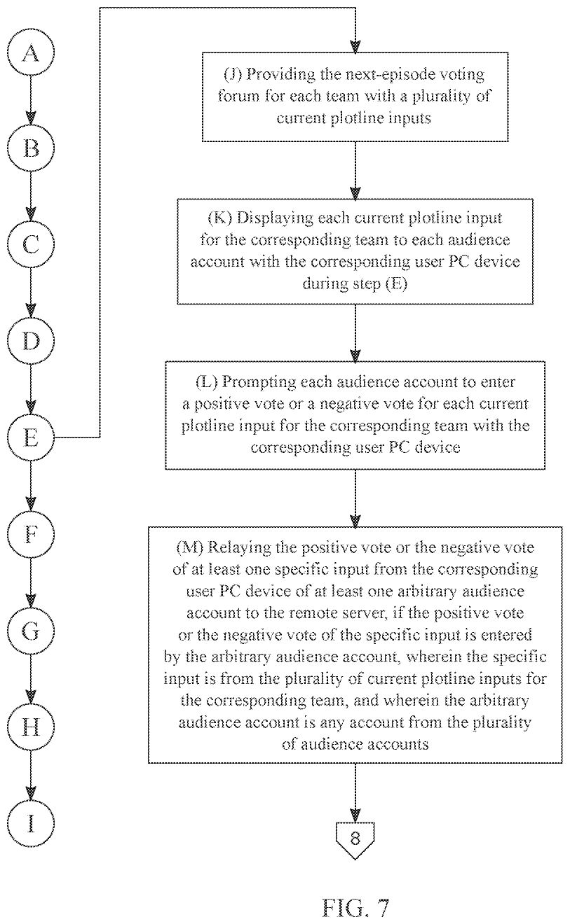

In order to provide equal opportunity for each plotline input, the next-episode voting forum must be conducted in such a way as to allow for the best responses, as decided by the contributing members, to rise to the top of the suggestion pool. To enable this, the next-episode voting forum for each team is provided with a plurality of current plotline inputs (Step J), as represented in FIG. 7. The plurality of current plotline inputs relates to the different written ideas expressed by the various members of the corresponding team. Each current plotline input for the corresponding team is displayed to each audience account with the corresponding user PC device during Step E (Step K). This arrangement allows each audience account to read the responses written by the rest of the corresponding team. Next, each audience account is prompted to enter a positive vote or a negative vote for each current plotline input for the corresponding team with the corresponding user PC device (Step L). A positive vote corresponds generally to approval of the content of a particular current plotline input, while a negative vote corresponds generally to disapproval of that current plotline input. Following the registration of a positive vote or a negative vote, the positive vote or the negative vote of at least one specific input from the corresponding user PC device of at least one arbitrary audience account is relayed to the remote server, if the positive vote or the negative vote of the specific input is entered by the arbitrary audience account, wherein the specific input is from the plurality of current plotline inputs for the corresponding team, and wherein the arbitrary audience account is any account from the plurality of audience accounts (Step M). Relaying this information to the remote server enables the remote server to store information and conduct calculations and other such logical processes to determine the most appropriate response.

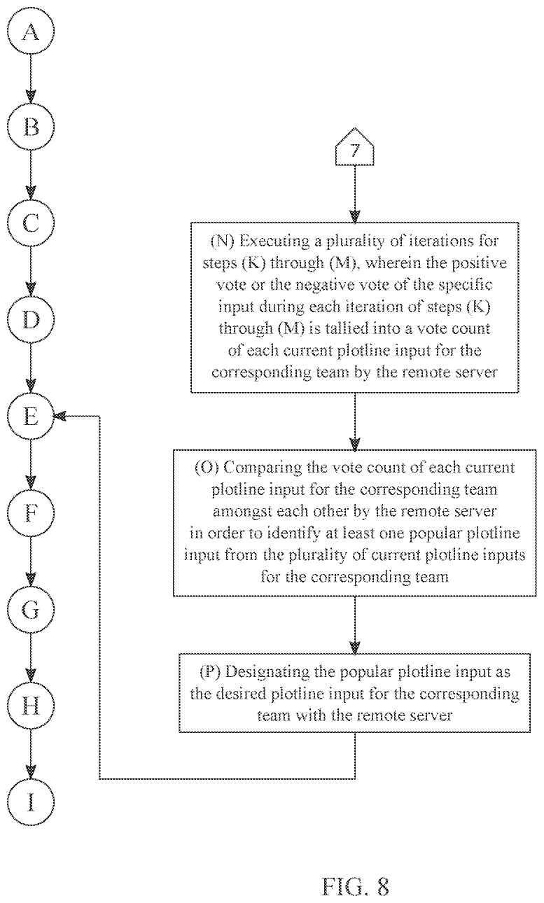

Steps K through M are effective at generating data that is useful in determining audience enthusiasm for different plotline possibilities. A plurality of iterations for Steps K through M are executed, wherein the positive vote or the negative vote of the specific input during each iteration of Steps K through M is tallied into a vote count of each current plotline input for the corresponding team by the remote server (Step N), as represented in FIG. 8. Thus, a vote count is calculated for each current plotline input, preferably by tallying the positive votes and the negative votes. The vote count of each current plotline input for the corresponding team is compared amongst each other by the remote server in order identify at least one popular plotline input from the plurality of current plotline inputs for the corresponding team (Step O). The at least one popular plotline input may also be determined based upon volatility, depending on the preference of the at least one administrator account or the plurality of audience accounts. Finally, the popular plotline input is designated as the desired plotline input for the corresponding team with the remote server (Step P). The popular plotline input is preferably chosen for subsequent script-writing and scene-planning tasks by showrunners.

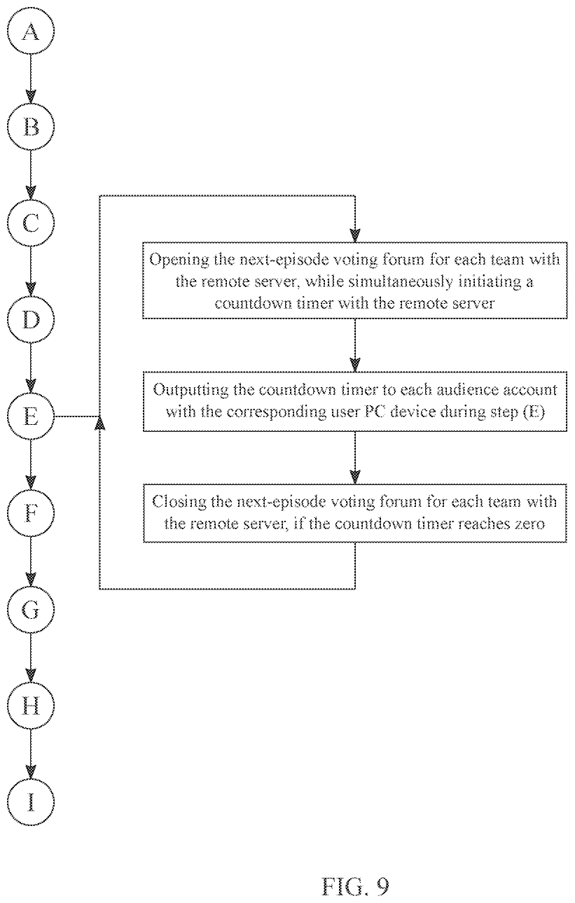

For practical and creative purposes, it is often helpful to provide a timer that restricts the available time for contributing to the next-episode voting forum. To enable this feature, the next-episode voting forum is opened for each team with the remote server, while simultaneously initiating a countdown timer with the remote server, as represented in FIG. 9. The countdown timer determines the amount of time before the next-episode voting forum is closed. The countdown timer is outputted to each audience account with the corresponding user PC device during Step E. In this way, each audience account is made aware of the amount of time remaining in which the audience account can contribute to the story development. Finally, the next-episode voting forum for each team is closed with the remote server, if the countdown timer reaches zero. Thus, all contributions to the next-episode voting forum must be inputted before the countdown timer reaches zero.

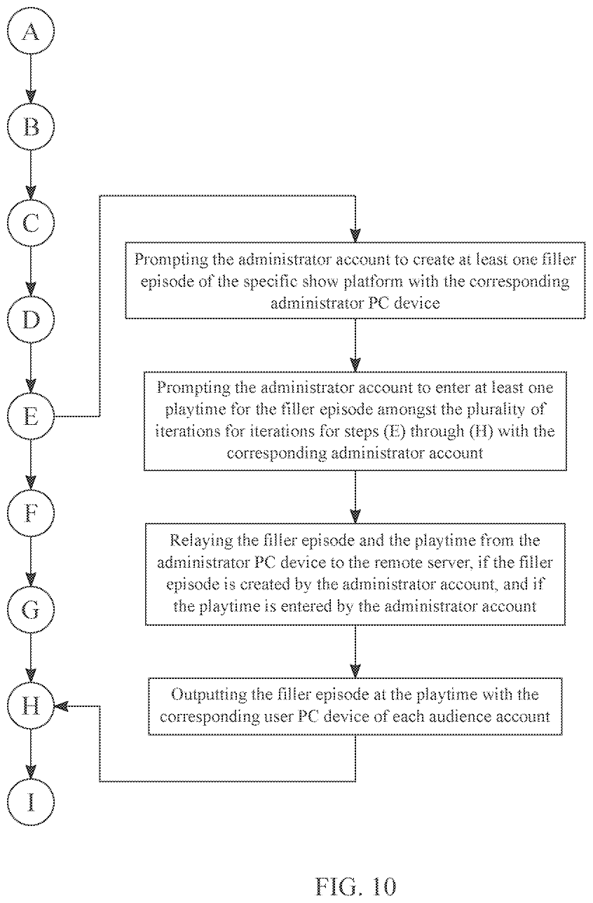

On several occasions, it may be advantageous to provide further guidance or character development without input from the audience in order to further assist character development or to create new and interesting conflicts. To achieve this, the administrator account is prompted to create at least one filler episode of the specific show platform with the corresponding administrator PC device, as represented in FIG. 10. The at least one filler episode may include information about a specific character's background or other side interactions between characters which preferably have no direct effect on the progression of the current plot as it is built by the plurality of audience accounts. The administrator account is then prompted to enter at least one playtime for the filler episode amongst the plurality of iterations for Steps E through H with the corresponding administrator account. The at least one playtime relates to a period in the future at which the filler episode will be aired. The filler episode and the playtime are relayed from the administrator PC device to the remote server, if the filler episode is created by the administrator account, and if the playtime is entered by the administrator account. Thus, the remote server is prepared to store and distribute the filler episode to the plurality of audience accounts. The filler episode is then outputted at the playtime with the corresponding user PC device of each audience account. In this way, the plurality of audience accounts may view the filler episode, which may affect their opinions of characters and the way they should be developed.

Although the invention has been explained in relation to its preferred embodiment, it is to be understood that many other possible modifications and variations can be made without departing from the spirit and scope of the invention as hereinafter claimed.

What is claimed is:

1. A method of creating a plotline though audience interaction, the method comprises the steps of:
(A) providing a plurality of user accounts, at least one administrator account, and a plurality of show platforms managed by at least one remote server, wherein each user account is associated with a corresponding user personal computing (PC) device, and wherein the administrator account is associated with a corresponding administrator PC device, and wherein each show platform includes a pilot episode and a plurality of teams;
(B) prompting each user account to join at least one specific show platform with the corresponding user PC device, wherein the specific show platform is from the plurality of show platforms;
(C) outputting the pilot episode of the specific show platform with the corresponding user PC device of each audience account, wherein the specific show platform is selected to be joined by each audience account, and wherein the plurality of audience accounts is from the plurality of user accounts;
(D) grouping each audience account into a corresponding team from the plurality of teams for the specific show platform through the remote server;
(E) executing a next-episode voting forum for each team of the specific show platform through the remote server in order to retrieve at least one desired plotline input from each team of the specific show platform;
(F) prompting the administrator account to create a next episode of the specific show platform with the corresponding administrator PC device by incorporating the desired plotline input from each team of the specific show platform;
(G) relaying the next episode from the administrator PC device to the remote server, if the next episode is selected to be created by the administrator account;
(H) outputting the next episode of the specific show platform with the corresponding user PC device of each audience account; and
(I) executing a plurality of iterations for steps (E) through (H), until the administrator account terminates the plurality of iterations for steps (E) through (H).

2. The method of creating a plotline though audience interaction, the method as claimed in 1 comprises the steps of:
providing the pilot episode for each show platform with a background story, a plurality of characters, an audience-solvable objective, and a cliffhanger; and
outputting the background story, the plurality of characters, the audience-solvable objective, and the cliffhanger for the specific show platform during step (C).

3. The method of creating a plotline though audience interaction, the method as claimed in 1 comprises the steps of:
prompting each audience account to select a desired team with the corresponding user PC device during step (D), wherein the desired team is from the plurality of teams for the specific team platform;
retrieving the desired team for each audience account from the corresponding user PC device to the remote server; and
designating the desired team as the corresponding team for each audience account with the remote server.

4. The method of creating a plotline though audience interaction, the method as claimed in 1 comprises the steps of:
providing the next-episode voting forum for each team with a plurality of current plotline inputs;
prompting each audience account to enter at least one new plotline input with the user PC device during step (E);
relaying the new plotline input from the corresponding user PC device of at least one arbitrary audience account to the remote server, if the new plotline input is entered by the arbitrary audience account, wherein the arbitrary audience account is any account from the plurality of audience accounts; and
appending the new plotline input into the plurality of current plotline inputs for the corresponding team of the arbitrary account with the remote server.

5. The method of creating a plotline though audience interaction, the method as claimed in 1 comprises the steps of:
(J) providing the next-episode voting forum for each team with a plurality of current plotline inputs;
(K) displaying each current plotline input for the corresponding team to each audience account with the corresponding user PC device during step (E);
(L) prompting each audience account to enter a positive vote or a negative vote for each current plotline input for the corresponding team with the corresponding user PC device;
(M) relaying the positive vote or the negative vote of at least one specific input from the corresponding user PC device of at least one arbitrary audience account to the remote server, if the positive vote or the negative vote of the specific input is entered by the arbitrary audience account, wherein the specific input is from the plurality of current plotline inputs for the corresponding team, and wherein the arbitrary audience account is any account from the plurality of audience accounts;
(N) executing a plurality of iterations for steps (K) through (M), wherein the positive vote or the negative vote of the specific input during each iteration of steps (K) through (M) is tallied into a vote count of each current plotline input for the corresponding team by the remote server;
(O) comparing the vote count of each current plotline input for the corresponding team amongst each other by the remote server in order identify at least one popular plotline input from the plurality of current plotline inputs for the corresponding team; and
(P) designating the popular plotline input as the desired plotline input for the corresponding team with the remote server.

6. The method of creating a plotline though audience interaction, the method as claimed in 1 comprises the steps of:
opening the next-episode voting forum for each team with the remote server, while simultaneously initiating a countdown timer with the remote server;
outputting the countdown timer to each audience account with the corresponding user PC device during step (E); and
closing the next-episode voting forum for each team with the remote server, if the countdown timer reaches zero.

7. The method of creating a plotline though audience interaction, the method as claimed in 1 comprises the steps of:
prompting the administrator account to create at least one filler episode of the specific show platform with the corresponding administrator PC device;
prompting the administrator account to enter at least one playtime for the filler episode amongst the plurality of iterations for steps (E) through (H) with the corresponding administrator account;
relaying the filler episode and the playtime from the administrator PC device to the remote server, if the filler episode is created by the administrator account, and if the playtime is entered by the administrator account; and
outputting the filler episode at the playtime with the corresponding user PC device of each audience account.
